(19) United States
(12) Patent Application Publication
(10) Pub. No.: US 2026/0245925 A1
(43) Pub. Date: Aug. 20, 2026

(54) FUEL CELL SYSTEM

(71) Applicant: AISIN CORPORATION, Kariya, Aichi (JP)

(72) Inventors: Taiga MURAKAMI, Kariya-shi, Aichi-ken (JP); Koji UEYAMA, Kariya-shi, Aichi-ken (JP)

(73) Assignee: AISIN CORPORATION, Kariya, Aichi (JP)

(21) Appl. No.: 19/156,183

(22) PCT Filed: Mar. 21, 2024
(86) PCT No.: PCT/JP2024/011108

§ 371 Date: Aug. 13, 2025

(30) Foreign Application Priority Data
Mar. 24, 2023 (JP) 2023-048435
Mar. 24, 2023 (JP) 2023-048605

(51) Int. Cl. H01M 8/04089; H01M 8/04223; H01M 8/04225; H01M 8/04302; H01M 8/0432; H01M 8/04746; H01M 8/04791; H01M 8/04992; H01M 8/12; H01M 8/2455

(52) U.S. Cl. CPC H01M 8/04089; H01M 8/04225; H01M 8/04231; H01M 8/04302; H01M 8/0432; H01M 8/04753; H01M 8/04798; H01M 8/04992; H01M 8/12; H01M 8/2455

(57) ABSTRACT

At the time of system start-up, a fuel cell system supplies oxidant gas, performs a fuel pre-charging step of supplying fuel gas until an oxygen concentration remaining in a fuel line from a fuel supply system to a combustion unit becomes equal to or lower than a predetermined concentration at a supply flow rate of the fuel gas at which a fuel concentration of the combustion unit is equal to or lower than a lower explosion limit with respect to a supply flow rate of the oxidant gas, and then performs an ignition step of performing ignition in the combustion unit.

### CROSS REFERENCE TO RELATED APPLICATIONS

This application is a National Stage of International Application No. PCT/JP2024/011108 filed on Mar. 21, 2024, claiming priority based on Japanese Patent Application No. 2023-048435 filed on Mar. 24, 2023 and Japanese Patent Application No. 2023-048605 filed on Mar. 24, 2023.

### TECHNICAL FIELD

The present specification discloses a fuel cell system.

### BACKGROUND ART

Conventionally, as this type of fuel cell system, there has been proposed a fuel cell system including a reformer, a solid oxide fuel cell, a fuel collecting unit in which gas passing through the solid oxide fuel cell is collected, a combustion unit that burns gas blown out of the fuel collecting unit, and an igniter used for ignition in the combustion unit (see, for example, Patent Literature 1). In this system, at the time of start-up, prepurge is performed in which various gases remaining in the system are discharged to the outside of the system by supplying power generating air and reforming air, and then the supply of fuel is started, and the air staying in the fuel collecting unit is replaced with fuel having a high concentration exceeding the upper limit value of the combustible range of the fuel. The supply of the reforming air is then started, and the gas blown from the fuel collecting unit to the combustion unit is ignited.

### CITATION LIST

### Patent Literature

Patent Literature 1: JP 2016-207413 A

### SUMMARY OF THE DISCLOSURE

### Technical Problems

In the fuel cell system described above, when the fuel concentration deviates from a target concentration due to tolerances of an auxiliary machine and control, or the like, there is a risk of backfire from the combustion unit to the fuel line. It is conceivable to use a backfire prevention device, but this leads to an increase in cost. In addition, in a fuel cell system in which a plurality of power generation modules each including one or more fuel cell stacks are connected, when fuel gas is supplied and ignited in a combustor when the system starts up, uniform supply of the fuel gas to each power generation module may cause backfire due to shortage of the fuel gas in some power generation modules. It is conceivable to use a backfire prevention device, but this leads to an increase in cost.

The present disclosure provides a fuel cell system in which ignition in a combustion unit is performed more safely at low cost when a system starts up.

### Solutions to Problems

The fuel cell system of the present disclosure adopts the following means in order to achieve the above main object.

A fuel cell system of the present disclosure includes a fuel cell stack that generates power by a reaction between fuel gas and oxidant gas, a combustion unit that burns mixed gas of residual fuel gas and residual oxidant gas from the fuel cell stack, an igniter used for ignition in the combustion unit, a case that has a heat insulating property and houses the fuel cell, the combustion unit, and the igniter, a fuel supply system that supplies fuel gas to the fuel cell stack, an oxidant gas supply system that supplies oxidant gas to the fuel cell stack, and a control unit that, at a time of system start-up, supplies the oxidant gas, performs a fuel pre-charging step of supplying the fuel gas until an oxygen concentration remaining in a fuel line from the fuel supply system to the combustion unit becomes equal to or lower than a predetermined concentration at a supply flow rate of the fuel gas at which a fuel concentration of the combustion unit is equal to or lower than a lower explosion limit with respect to a supply flow rate of the oxidant gas, and then performs an ignition step of performing ignition in the combustion unit.

In the fuel cell system of the present disclosure, at the time of system start-up, the fuel pre-charging step of supplying the fuel gas until the oxygen concentration remaining in the fuel line from the fuel supply system to the combustion unit becomes equal to or lower than a predetermined concentration at the supply flow rate of the fuel gas at which the fuel concentration of the combustion unit is equal to or lower than the lower explosion limit. Therefore, it is possible to prevent flame from reversely firing to the fuel line at the time of ignition in the combustion unit and to safely perform ignition in the combustor. In addition, it is not necessary to provide a dedicated device such as a backfire prevention device, and the cost can be reduced.

### BRIEF DESCRIPTION OF DRAWINGS

FIG. 1 is a schematic configuration diagram of a fuel cell system according to the present embodiment.

FIG. 2 is a schematic configuration diagram of a plurality of power generation units each including a power generation module and an auxiliary machine.

FIG. 3 is a schematic configuration diagram of the power generation module.

FIG. 4 is a flowchart illustrating an example of a start-up process.

FIG. 5 is a flowchart illustrating an example of a hydrogen pre-charging step process.

FIGS. 6A and 6B are explanatory diagrams illustrating examples of a required replacement amount, a hydrogen charging time, an air flow rate, and a hydrogen flow rate for each power generation module in the hydrogen pre-charging step at the time of initial start-up.

FIG. 7 is an explanatory diagram illustrating a state of a temporal change in hydrogen flow rate and hydrogen integrated flow rate for each power generation module in the hydrogen pre-charging step.

FIG. 8 is an explanatory diagram illustrating an example of a required replacement amount acquiring map used at the time of system restart-up.

FIG. 9 is an explanatory diagram illustrating examples of a required replacement amount, a hydrogen charging time, an air flow rate, and a hydrogen flow rate for each power generation module in the hydrogen pre-charging step at the time of restart-up.

FIG. 10 is a flowchart illustrating an example of a hydrogen pre-charging step process according to another embodiment.

FIG. 11 is an explanatory diagram illustrating a state of a temporal change in hydrogen flow rate and hydrogen integrated flow rate for each power generation module in the hydrogen pre-charging step according to another embodiment.

FIG. 12 is a flowchart illustrating an example of a hydrogen pre-charging step process according to yet another embodiment.

FIG. 13 is a flowchart illustrating an example of a first ignition step process.

FIG. 14 is a flowchart illustrating an example of a second ignition step process.

FIG. 15 is a schematic configuration diagram of a fuel cell system according to another embodiment.

FIG. 16 is a schematic configuration diagram of a power generation module according to another embodiment.

### DESCRIPTION OF EMBODIMENTS

Embodiments for carrying out the present disclosure will be described with reference to the drawings.

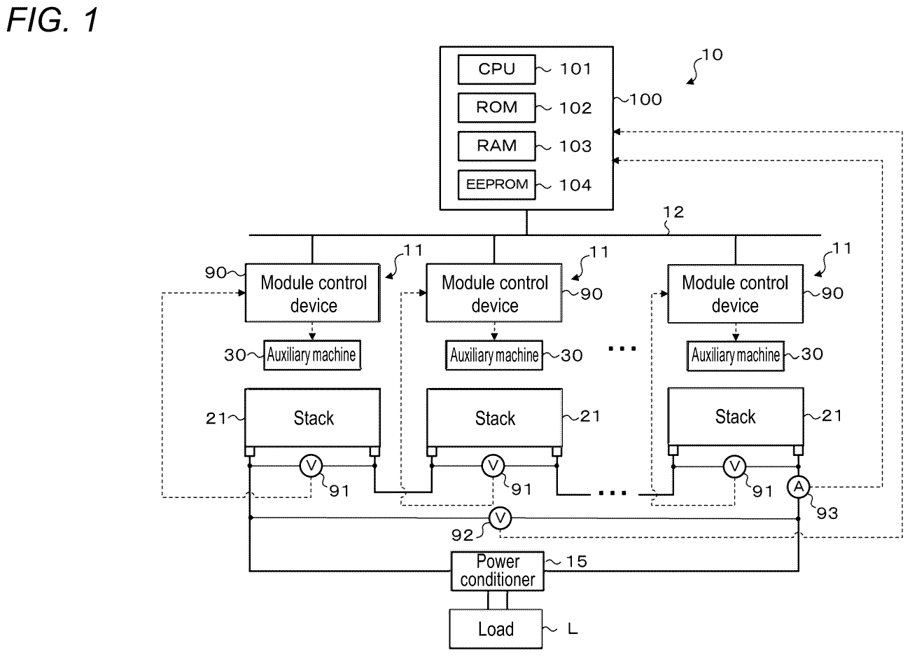

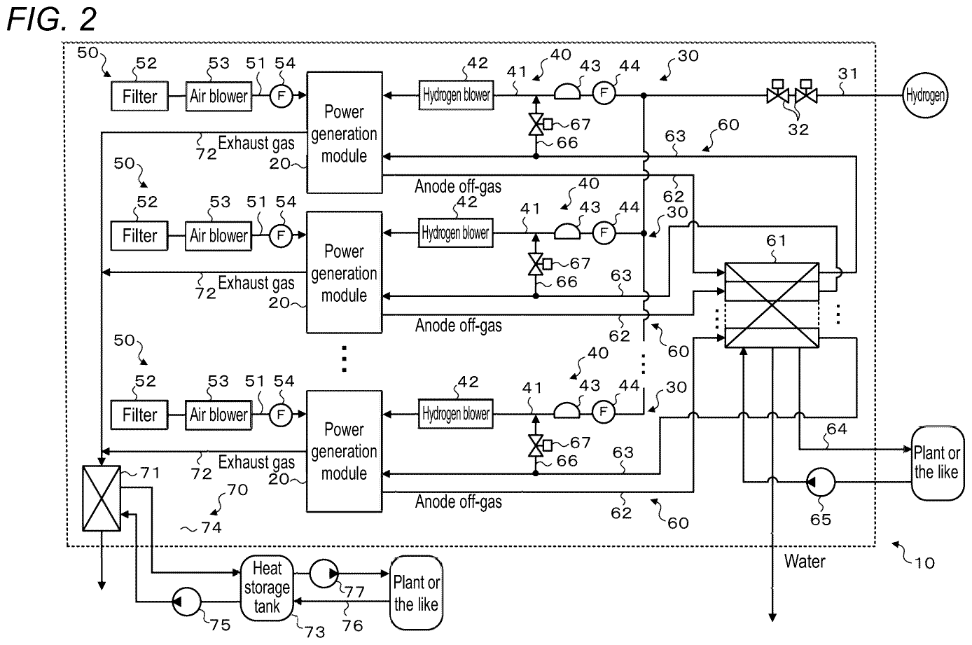

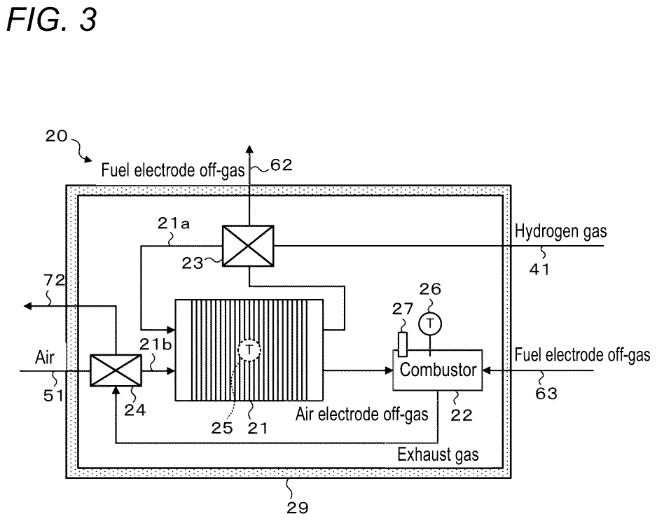

FIG. 1 is a schematic configuration diagram of a fuel cell system 10 according to the present embodiment, FIG. 2 is a schematic configuration diagram of a plurality of power generation units 11 each including a power generation module 20 and an auxiliary machine 30, and FIG. 3 is a schematic configuration diagram of the power generation module 20.

As illustrated in FIG. 1, the fuel cell system 10 of the embodiment includes a plurality of power generation units 11 and an integrated control device 100 that manages the plurality of power generation units 11.

As illustrated in FIGS. 1 and 2, each of the plurality of power generation units 11 includes the power generation module 20 including a fuel cell stack 21, various auxiliary machines 30 necessary for operation of the fuel cell stack 21, and a module control device 90 that controls various auxiliary machines 30.

As illustrated in FIG. 3, the power generation module 20 includes a combustor 22, and heat exchangers 23 and 24 in addition to the fuel cell stack 21, and these components are housed in a module case 29 with a heat insulating property. The various auxiliary machines 30 include a fuel supply system 40, an air supply system 50, a circulation system 60, an exhaust heat recovery system 70, and the like (see FIG. 2).

The fuel cell stack 21 includes a plurality of solid oxide unit cells each including an electrolyte made of stabilized zirconia (for example, YSZ) or the like, a fuel electrode made of a composite of a catalytic metal such as Ni and stabilized zirconia or the like disposed on one surface side of the electrolyte, and an air electrode such as LSCF disposed on the other surface side of the electrolyte. Each fuel cell stack 21 generates power by a reaction between hydrogen contained in fuel gas and oxygen contained in oxidant gas (air). A temperature sensor 25 is disposed the near fuel cell stack 21. The temperature sensor 25 detects a temperature (stack temperature Tst) correlated with the temperature of the fuel cell stack 21.

As illustrated in FIG. 3, one end of a fuel gas supply pipe 21a is connected to a fuel electrode inlet of the fuel cell stack 21, and the fuel supply system 40 is connected to the other end of the fuel gas supply pipe 21a. In addition, the heat exchanger 23 for exchanging heat between fuel gas flowing from the fuel supply system 40 through the fuel gas supply pipe 21a and fuel electrode off-gas discharged from a fuel electrode outlet of the fuel cell stack 21 is disposed in the fuel gas supply pipe 21a. One end of an oxidant gas supply pipe 21b is connected to an air electrode inlet of the fuel cell stack 21, and the air supply system 50 is connected to the other end of the oxidant gas supply pipe 21b. In addition, the heat exchanger 24 for exchanging heat between oxidant gas flowing from the air supply system 50 through the oxidant gas supply pipe 21b and combustion exhaust gas discharged from the combustor 22 is disposed in the oxidant gas supply pipe 21b.

A fuel electrode off-gas pipe 62 is connected to the fuel electrode outlet of the fuel cell stack 21. The fuel electrode off-gas pipe 62 is laid so as to pass through the heat exchanger 34. The combustor 22 is connected to an oxidant gas electrode outlet of the fuel cell stack 21 via an oxidant gas electrode off-gas pipe.

The combustor 22 includes an igniter 27, and combusts mixed gas of fuel electrode off-gas and oxidant gas electrode off-gas introduced into the combustor 22. The combustion exhaust gas generated by the combustion of the mixed gas in the combustor 22 is discharged to the outside of the module case 29 through the heat exchanger 24. A temperature sensor 26 for detecting the temperature (combustor temperature Tf) of a combustion zone in the combustor 22 is disposed in the combustor 22.

Hydrogen gas supplied as fuel gas by the fuel supply system 40 is introduced into the fuel electrode of the fuel cell stack 21 through the fuel gas supply pipe 21a, and air supplied as oxidant gas by the air supply system 50 is introduced into the air electrode of the fuel cell stack 21 through the oxidant gas supply pipe 21b. Oxide ions (O²⁻) are generated at the air electrode, and the oxide ions pass through the electrolyte and react with hydrogen at the fuel electrode, thereby obtaining electric energy. The fuel electrode off-gas that has not been used for the electrochemical reaction (power generation) in the fuel electrode of each unit cell exchanges heat with the fuel gas (hydrogen gas) supplied from the fuel supply system 40 to the fuel electrode in the heat exchanger 23, and then is discharged to the outside of the module case 29. The fuel electrode off-gas is then supplied to the circulation system 60 through the fuel electrode off-gas pipe 62, cooled by a condenser 61 provided in the circulation system 60 to remove water vapor contained in the fuel electrode off-gas, and then supplied to the combustor 22 through a fuel electrode off-gas pipe 63. The air electrode off-gas that has not been used for the electrochemical reaction (power generation) in the air electrode of each unit cell is directly supplied to the combustor 22. The fuel electrode off-gas introduced into the combustor 22 is combustible gas containing hydrogen, is mixed with the air electrode off-gas containing oxygen introduced into the combustor 22, and the mixed gas is combusted in the combustor 22, so that the fuel cell stack 21 is maintained at an appropriate temperature by combustion heat. In the combustor 22, combustion exhaust gas is generated, and the combustion exhaust gas exchanges heat with air supplied from the air supply system 50 to the air electrode in the heat exchanger 24, and then is supplied to the exhaust heat recovery system 70 through a combustion exhaust gas pipe 72. The exhaust heat of the combustion exhaust gas is recovered by the exhaust heat recovery system 70, and then the combustion exhaust gas is discharged to the outside air.

The fuel supply system 40 includes a hydrogen supply pipe 31 having one end connected to a hydrogen supply source such as a hydrogen tank, a branch pipe 41 branching from the other end of the hydrogen supply pipe 31 to each power generation module 20, and a hydrogen blower 42 disposed in each branch pipe 41. By operating the hydrogen blower 42, the hydrogen gas in a hydrogen tank 2 is pumped (supplied) to the power generation module 20. Since the hydrogen blower 42 is disposed in each branch pipe 41, the supply amount of the hydrogen gas can be controlled for each power generation module 20 by individually controlling each hydrogen blower 42. An on-off valve 32 (dual valve), a negative pressure preventing valve (not illustrated), and the like are arranged in the hydrogen supply pipe 31, and a zero governor 43 (equalizer valve), a flow rate sensor 44, and the like are arranged in each branch pipe 41 in addition to the hydrogen blower 42. The flow rate sensor 44 detects the flow rate (fuel flow rate Fg) of hydrogen gas (fuel gas) flowing through the branch pipe 41 per unit time. The hydrogen gas introduced into the power generation module 20 is increased in temperature by heat exchange with the fuel electrode off-gas in the heat exchanger 23, and then supplied to the fuel electrode of the fuel cell stack 21.

The air supply system 50 includes an air supply pipe 51 connected to each power generation module 20, a filter 52 provided at an inlet of each air supply pipe 51, and an air blower 53 disposed in each air supply pipe 51. By operating the air blower 53, air is sucked from the filter 52 and the sucked air is pumped (supplied) to the power generation module 20. Since the air blower 53 is disposed in each air supply pipe 51, the supply amount of air can be controlled for each power generation module 20 by individually controlling each air blower 53. A flow rate sensor 54 is disposed in each air supply pipe 51. The flow rate sensor 54 detects the flow rate (air flow rate Fa) of air flowing through the air supply pipe 51 per unit time. Air introduced into the power generation module 20 is increased in temperature by heat exchange with combustion exhaust gas in the heat exchanger 24, and then supplied to the air electrode of the fuel cell stack 21.

The circulation system 60 includes the condenser 61 having individual heat exchange flow paths for the individual power generation modules 20, the fuel electrode off-gas pipe 62 having one end connected to each power generation module 20 (fuel electrode side of the fuel cell stack 21) and the other end connected to an inlet of each heat exchange flow path of the condenser 61, the fuel electrode off-gas pipe 63 having one end connected to an outlet of each heat exchange flow path of the condenser 61 and the other end connected to each power generation module 20 (combustor 22 side), a circulation pipe 64 connecting the condenser 61 and a heat utilizing apparatus, and a circulation pump 65 disposed in the circulation pipe 64. The fuel electrode off-gas discharged from the fuel electrode side of the fuel cell stack 21 is supplied to the combustor 22 after water vapor contained in the fuel electrode off-gas is removed by the condenser 61 through heat exchange with a heat exchange medium circulating in the circulation pipe 64 by operating the circulation pump 65.

In addition, the circulation system 60 includes a reflux pipe 66 that branches from the fuel electrode off-gas pipe 63 on the downstream side of the condenser 61 and is connected between the hydrogen blower 42 and the zero governor 43 in the branch pipe 41 of the fuel supply system 40, and a regulating valve 67 (electromagnetic valve) disposed in the reflux pipe 66. By opening the regulating valve 67, part of the fuel electrode off-gas that has passed through the condenser 61 can be refluxed and supplied from the fuel supply system 40 to the power generation module 20. Note that an orifice may be provided in the reflux pipe 66 instead of the regulating valve 67.

The exhaust heat recovery system 70 includes a heat exchanger 71 connected to each combustion exhaust gas pipe 72, a heat storage tank 73, a circulation pipe 74 connecting the heat exchanger 71 and the heat storage tank 73, and a circulation pump 75 disposed in the circulation pipe 74. By operating the circulation pump 75, the combustion exhaust gas supplied to the heat exchanger 71 exchanges heat with a heat exchange fluid in the heat storage tank 73, and the exhaust heat of the combustion exhaust gas is recovered in the heat storage tank 73. The exhaust heat recovery system 70 also includes a circulation pipe 76 connecting the heat storage tank 73 and a heat utilizing apparatus installed in a plant or the like, and a circulation pump 77 disposed in the circulation pipe 76. By operating the circulation pump 77, the heat recovered in the heat storage tank 73 can be supplied to the heat utilizing apparatus.

The fuel cell stack 21 included in each of the plurality of power generation units 11 is connected in series to a single power conditioner 15, and the DC power generated in each fuel cell stack 21 is converted by the power conditioner 15 and supplied to a load L. A voltage sensor 91 for detecting the output voltage of the fuel cell stack 21 is disposed between the output terminals of the fuel cell stack 21 in each power generation module 20. A voltage sensor 92 for detecting the voltage (total voltage Vt) of the entire fuel cell stacks 21 is disposed between one terminal (fuel electrode terminal) of the fuel cell stack 21 disposed at one end among the fuel cell stacks 21 connected in series and the other terminal (air electrode terminal) of the fuel cell stack 21 disposed at the other end. A current sensor 93 that detects a current flowing through a power line connecting the fuel cell stacks 21 in series is disposed in the power line.

The power conditioner 15 includes a DC/DC converter and an inverter, converts DC power from each fuel cell stack 21 into AC power having a voltage (for example, AC 200 V) communicable with a system power supply, and outputs the AC power. A power supply board (not illustrated) is connected to the power conditioner 15. The power supply board converts power from each fuel cell stack 21 into DC power suitable for driving the various auxiliary machines 30, the module control device 90, and the integrated control device 100, and supplies the DC power to each of them.

A cooling fan for cooling the power conditioner 15 and the power supply board and a ventilation fan (both not illustrated) are arranged in an auxiliary machine chamber in which the power conditioner 15, the power supply board, and the like are arranged.

Although not illustrated, each module control device 90 is configured as a microprocessor centered on a CPU, and includes a ROM storing a processing program, a RAM temporarily storing data, an input and output port, and a communication port in addition to the CPU. The stack temperature Tst from the temperature sensor 25 disposed near the fuel cell stack 21 of the corresponding power generation module 20, the combustor temperature Tf from the temperature sensor 26 disposed in the combustor 22, a voltage V from the voltage sensor 91 disposed between the output terminals of the corresponding fuel cell stack 21, a fuel flow rate Qg from the flow rate sensor 44 disposed in the corresponding branch pipe 41 of the fuel supply system 40, an air flow rate Qa from the flow rate sensor 54 disposed in the corresponding air supply pipe 51 of the air supply system 50, and the like are input to each module control device 90 via the input port. In addition, a control signal to the corresponding hydrogen blower 42 of the fuel supply system 40, a control signal to the corresponding air blower 53 of the air supply system 50, a control signal to the corresponding regulating valve 67 of the circulation system 60, and the like are output from each module control device 90 via the output port.

The integrated control device 100 is configured as a microprocessor centered on a CPU 101, and includes a ROM 102 storing a processing program, a RAM 103 temporarily storing data, an EEPROM 104 as a nonvolatile memory, a timer (not illustrated), an input and output port, and a communication port in addition to the CPU 101. The total voltage Vt detected by the voltage sensor 92, a current I from the current sensor 93, and the like are input to the integrated control device 100 via the input port. In addition, a control signal to the on-off valve 32, a control signal to the circulation pump 65 of the circulation system 60, a control signal to the circulation pumps 75 and 77 of the exhaust heat recovery system 70, and the like are output from the integrated control device 100 via the output port. The integrated control device 100 is communicably connected to each module control device 90 via a communication bus 12, and exchanges control signals and data with each other.

Next, an operation of the fuel cell system 10 configured as described above according to the present embodiment will be described.

When the start-up of the fuel cell system 10 is requested from the host system, the integrated control device 100 transmits a start-up instruction to perform a start-up process to each module control device 90. The start-up process includes an air purge step, a hydrogen pre-charging step, an ignition step (first ignition step and second ignition step), and a warm-up step, and each module control device 90 sequentially performs the individual steps in response to instructions from the integrated control device 100. When warm-up of each fuel cell stack 21 is completed and the fuel cell stack reaches a power generatable state, the integrated control device 100 transmits a power generation instruction to each module control device 90.

In a power generation process, each module control device 90 inputs a target fuel flow rate Fgtag and a target air flow rate Fatag set by the integrated control device 100 on the basis of requested power required for the system, and controls the corresponding hydrogen blower 42 and air blower 53 on the basis of each input target flow rate. Specifically, each module control device 90 drives and controls the hydrogen blower 42 by feedback control on the basis of the difference between the target fuel flow rate Fgtag and the fuel flow rate Fg detected by the flow rate sensor 44, and drives and controls the air blower 53 by feedback control on the basis of the difference between the target air flow rate Fatag and the air flow rate Fa detected by the flow rate sensor 54.

When the stop of the system is requested, each module control device 90 performs a stop process in response to an instruction from the integrated control device 100. In the stop process, each module control device 90 controls the hydrogen blower 42 in a manner that hydrogen gas is supplied at a flow rate that does not cause oxidation degradation of the electrode of the fuel cell stack 21, and controls the air blower 53 in a manner that air is supplied at a flow rate necessary for cooling the fuel cell stack 21. When the stack temperature Tst from the temperature sensor 94 decreases to a temperature lower than a predetermined temperature, each module control device 90 stops the supply of the fuel gas and the air. When the stop of the system is completed, the integrated control device 100 starts the measurement of an elapsed time (system stop time). The system stop time is used in a hydrogen pre-charging step process to be described later.

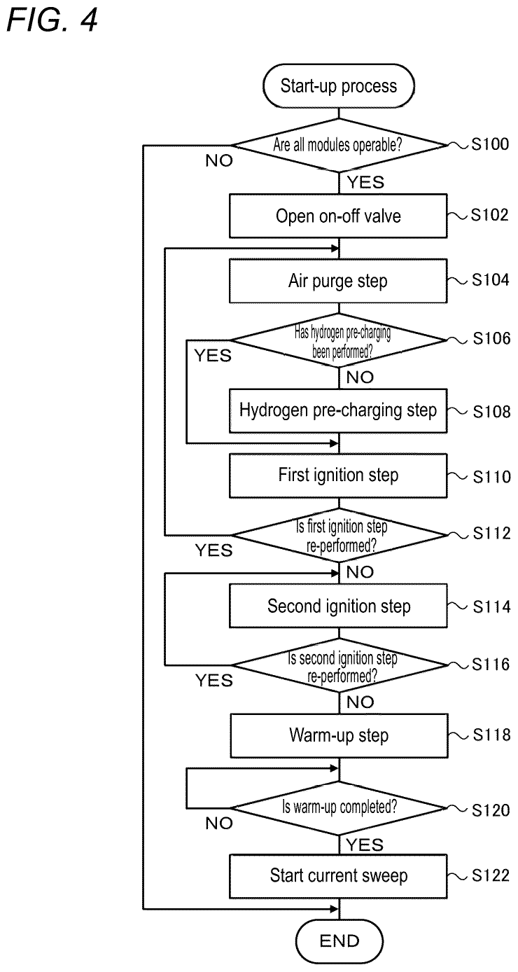

Details of the start-up process will be further described. FIG. 4 is a flowchart illustrating an example of the start-up process performed by the integrated control device 100. This process is performed when the start-up of the fuel cell system 10 is requested from the host system.

In the start-up process, after checking that each power generation module 20 is in an operable state (step S100), the integrated control device 100 opens the on-off valve 32 (step S102), and transmits various instructions to perform the start-up process to the module control device 90 of each power generation module 20.

The integrated control device 100 first instructs each module control device 90 to perform an air purge step of supplying air so that the inside of the combustor 22 is purged (step S104). Each module control device 90 that has received the instruction performs the air purge step by controlling the corresponding air blower 53 at a predetermined air flow rate. The air purge step is performed until the combustor temperature Tf from the temperature sensor 26 is lower than a predetermined temperature a (for example, 200° C.) and the state continues for a predetermined time. When the air purge step ends, if the hydrogen pre-charging step has not been performed (NO in step S106), the integrated control device 100 instructs each module control device 90 to perform the hydrogen pre-charging step (step S108). Here, the hydrogen pre-charging step is a step of replacing oxygen (air) remaining in a fuel gas line (branch pipe 41, fuel gas supply pipe 21a, and fuel electrode off-gas pipes 62 and 63) from the hydrogen supply system 40 of each power generation module 20 to the combustor 22 with hydrogen to be charged from the hydrogen supply system 40 until the hydrogen concentration in the fuel gas line becomes equal to or higher than an upper explosion limit (75%). This hydrogen pre-charging step is performed in order to prevent flame from reversely firing to the fuel gas line when the igniter 27 is turned on and ignition in the combustor 22 is performed in a subsequent ignition step (first ignition step). Details of the hydrogen pre-charging step will be described later.

When the hydrogen pre-charging step ends, the integrated control device 100 instructs each module control device 90 to perform the first ignition step (step S110). Each module control device 90 controls the hydrogen blower 42 and the air blower 53 in a manner that hydrogen gas and air are supplied at a hydrogen concentration (for example, the concentration near the lower combustion limit of hydrogen) predetermined in the combustion zone of the combustor 22, and then performs the first ignition step of turning on the igniter 27 to ignite the fuel gas and partially burn the fuel gas. In addition, each module control device 90 monitors a temperature change in combustor temperature Tf, determines whether or not the first ignition step is successful, and transmits the determination result to the integrated control device 100. The integrated control device 100 determines whether or not to re-perform the first ignition step on the basis of the determination result received from each module control device 90 (step S112). This determination is made on the basis of whether or not a determination result that the first ignition step has failed is received from any of the module control devices 90. When determining to re-perform the first ignition step, the integrated control device 100 instructs the module control device 90 of the corresponding power generation module 20 to perform the air purge step (step S104). Since the hydrogen pre-charging step has been performed (YES in step S106), the integrated control device 100 skips the hydrogen pre-charging step and instructs the module control device 90 of the corresponding power generation module 20 to re-perform the first ignition step (step S110). In re-performing of the first ignition step, in a case where the first ignition step fails in some of the power generation modules 20, the first ignition step may be re-performed only in the corresponding power generation modules 20, or the first ignition step may be re-performed in all the power generation modules 20.

Next, the integrated control device 100 instructs each module control device 90 to perform the second ignition step (step S114). Each module control device 90 controls the hydrogen blower 42 and the air blower 53 in a manner that hydrogen gas and air are supplied to at a hydrogen concentration (hydrogen concentration equal to or higher than the hydrogen concentration in the first ignition step) predetermined in the combustion zone of the combustor 22, thereby performing the second ignition step of completely combusting fuel gas. In addition, each module control device 90 monitors a temperature change in combustor temperature Tf, determines whether or not the second ignition step is successful, and transmits the determination result to the integrated control device 100. The integrated control device 100 determines whether or not to re-perform the second ignition step on the basis of the determination result received from each module control device 90 (step S116). This determination is made on the basis of whether or not a determination result that the second ignition step has failed is received from any of the module control devices 90. When determining to re-perform the second ignition step, the integrated control device 100 instructs the module control device 90 of the corresponding power generation module 20 to re-perform the second ignition step (step S114).

The integrated control device 100 then instructs each module control device 90 to perform a warm-up step (step S118). Each module control device 90 performs the warm-up step by setting the target fuel flow rate Fgtag and the target air flow rate Fatag and controlling the hydrogen blower 42 and the air blower 53 in a manner that the state of the fuel cell stack 21 reaches a power generatable state. In addition, each module control device 90 monitors the stack temperature Tst from the temperature sensor 25, and when the stack temperature Tst reaches a predetermined warm-up completion temperature, transmits a notification that the warm-up is completed to the integrated control device 100. When determining that the notification that the warm-up is completed is received from all the module control devices 90 (YES in step S120), the integrated control device 100 controls the power conditioner 15 to start current sweep, instructs each power generation module 20 to start the power generation operation (step S122), and ends the start-up process.

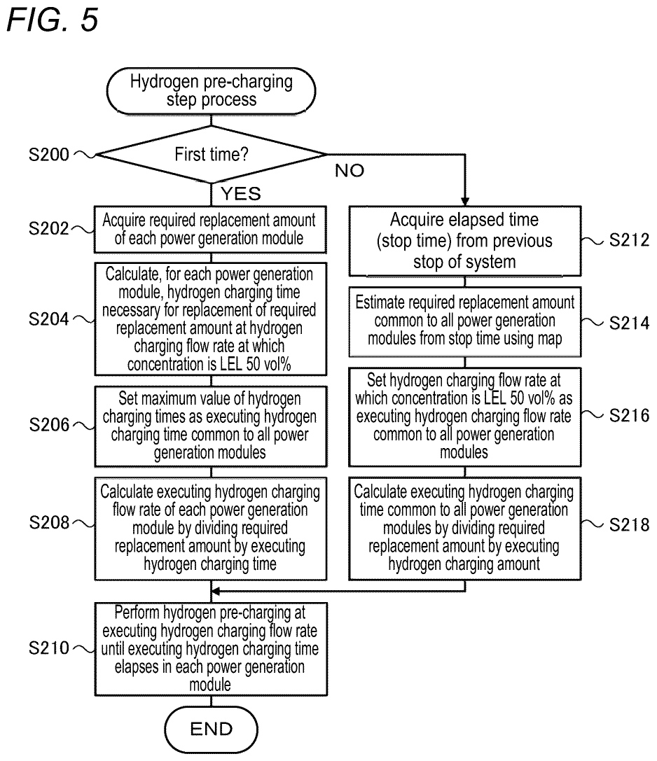

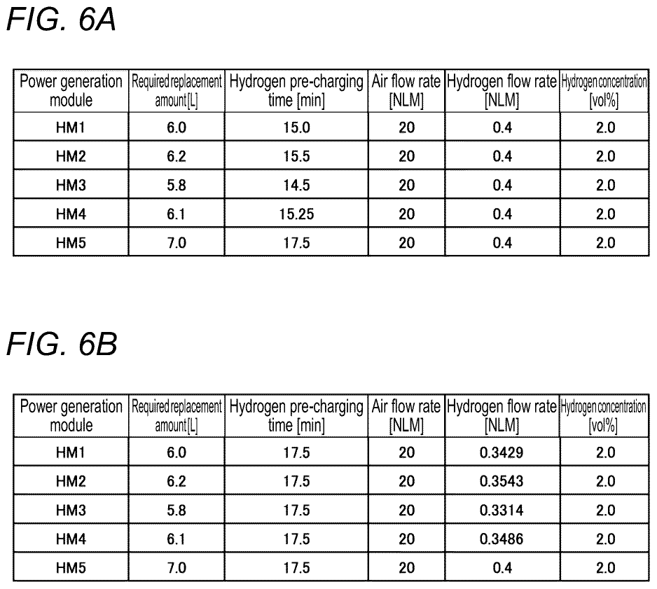

Next, details of the hydrogen pre-charging step performed in step S108 will be described. FIG. 5 is a flowchart illustrating an example of the hydrogen pre-charging step process. Hereinafter, the hydrogen pre-charging step process will be described with reference to FIGS. 6A and 6B as an example in which the fuel cell system 10 includes five power generation modules HM1 to HM5 as power generation modules 20.

In the hydrogen pre-charging step process, the integrated control device 100 determines whether or not the current system start-up is the first time (step S200). When determining that the current system start-up is the first time, the integrated control device 100 acquires, for each power generation module 20, a required replacement amount that is the amount of hydrogen necessary for replacing oxygen (air) remaining in a fuel gas line from the hydrogen supply system 40 to the combustor 22 with hydrogen until the hydrogen concentration in the fuel gas line becomes equal to or higher than the upper combustion limit (75%) (step S202). The required replacement amount is determined to be an amount depending on the pipe length of the fuel gas line for each power generation module 20. In the present embodiment, the pipe length (primary-side pipe length) from the branch point of the branch pipe 41 from the hydrogen supply pipe 31 to the hydrogen blower 42 differs for each power generation module 20, and the pipe length (secondary-side pipe length) from the hydrogen blower 42 to the combustor 22 is the same for all the power generation modules 20. The required replacement amount is stored in the ROM 102 in advance for each power generation module 20 based on the pipe length of each power generation module 20. The integrated control device 100 acquires the required replacement amount by reading the required replacement amount of the corresponding power generation module 20 from the ROM 102.

When acquiring the required replacement amount of each power generation module 20, the integrated control device 100 calculates, for each power generation module 20, a hydrogen charging time necessary for the replacement of the required replacement amount in a case where the hydrogen charging flow rate is set in a manner that the hydrogen concentration in the fuel zone of the combustor 22 is a concentration obtained by multiplying the lower combustion limit (4%) of hydrogen by a predetermined safety factor with respect to a predetermined air charging flow rate (step S204). For example, in a case where the air charging flow rate is 20 [NLM] and the safety factor is 0.5, the hydrogen charging flow rate is 0.4 [NLM], and the hydrogen charging time of the power generation module HM1 with a required replacement amount of 6.0 [L] is 15.0 [min] as illustrated in FIG. 6A. Similarly, the hydrogen charging time of the power generation module HM1 with a required replacement amount of 6.2 [L] is 15.5 [min], the hydrogen charging time of the power generation module HM3 with a required replacement amount of is 5.8 [L] is 14.5 [min], the hydrogen charging time of the power generation module HM4 with a required replacement amount of 6.1 [L] is 15.25 [min], and the hydrogen charging time of the power generation module HM5 with a required replacement amount of 7.0 [L] is 17.5 [min].

Next, the integrated control device 100 sets the maximum value of the calculated hydrogen charging times as the executing hydrogen charging time common to all the power generation modules 20 (step S206). As illustrated in FIG. 6B, since the maximum value of the hydrogen charging times of the power generation modules HM1 to HM5 is 17.5 [min], the executing hydrogen charging time common to all the power generation modules MH1 to MH5 is set to 17.5 [min]. The integrated control device 100 then calculates the executing hydrogen charging amount of each power generation module 20 by dividing the required replacement amount of each power generation module 20 by the common executing hydrogen charging time (step S208). As illustrated in FIG. 6B, since the executing hydrogen charging time is set to 17.5 [min], the executing hydrogen charging flow rate of the power generation module HM1 with a required replacement amount of 6.0 [L] is set to 0.3429 [NLM]. Similarly, the executing hydrogen charging flow rate of the power generation module HM1 with a required replacement amount of 6.2 [L] is set to 0.3543 [NLM], the executing hydrogen charging flow rate of the power generation module HM3 with a required replacement amount of is 5.8 [L] is set to 0.3314 [NLM], the executing hydrogen charging flow rate of the power generation module HM4 with a required replacement amount of 6.1 [L] is set to 0.3486 [NLM], and the executing hydrogen charging flow rate of the power generation module HM5 with a required replacement amount of 7.0 [L] is set to 0.4 [NLM].

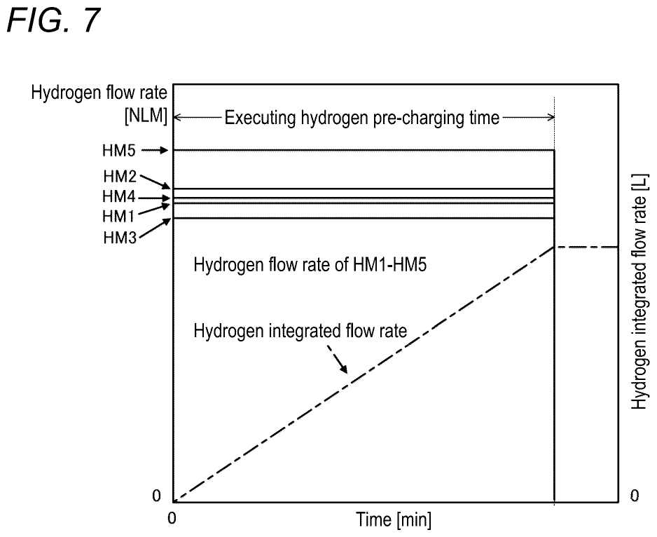

When the executing hydrogen charging time common to all the power generation modules 20 and the executing hydrogen charging flow rate of each power generation module 20 are set as described above, the integrated control device 100 transmits a hydrogen pre-charging instruction including the executing hydrogen charging time and the executing hydrogen charging flow rate to the corresponding module control device 90 (step S210), and ends the hydrogen pre-charging step process. Each module control device 90 that has received the hydrogen pre-charging instruction sets the executing hydrogen charging flow rate to the target fuel flow rate Fgtag, and controls the hydrogen blower 42 by feedback control in a manner that the fuel flow rate Fg from the flow rate sensor 44 matches the target fuel flow rate Fftag until the executing hydrogen charging time elapses. As a result, air in the fuel gas line from the fuel supply system 40 to the combustor 22 in each power generation module 20 can be replaced with hydrogen, and it is possible to prevent flame from reversely firing to the fuel gas line at the time of ignition in the combustor 22 in the next ignition step (first ignition step). In addition, since the required replacement amount is acquired for each power generation module 20 and the executing hydrogen charging flow rate and the executing hydrogen charging time are set based on the acquired required replacement amount, wasteful fuel consumption can be suppressed. As described above, since the executing hydrogen charging time is common to all the power generation modules 20, the hydrogen pre-charging step ends at the same timing in all the power generation modules 20 as illustrated in FIG. 7. Therefore, since the timing of ignition of the combustor 22 in the first ignition step performed after the hydrogen pre-charging step can be made to match in the individual power generation modules 20, the occurrence of backfire can be more reliably prevented.

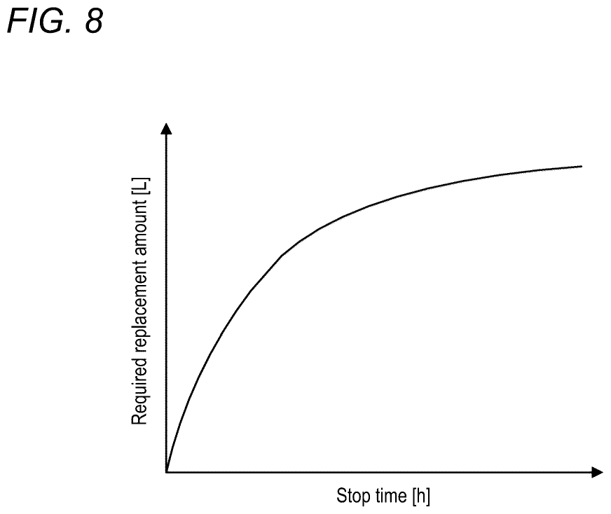

When determining that the current system start-up is not the first time but restart-up, the integrated control device 100 acquires an elapsed time (system stop time) from the previous stop of the system (step S212). Subsequently, the integrated control device 100 estimates a required replacement amount common to all the power generation modules 20 on the basis of the acquired system stop time (step S214). Immediately after the system is stopped, the fuel gas line from the fuel supply system 40 to the combustor 22 is filled with hydrogen gas. The hydrogen gas in the fuel gas line is then gradually replaced with air introduced from the combustion exhaust gas line or the like as time passes. Therefore, when restarting up the system, the integrated control device 100 estimates the required replacement amount necessary for replacing the air replaced from hydrogen with hydrogen again on the basis of the system stop time. In the present embodiment, the required replacement amount is estimated by experimentally determining the relationship between the system stop time and the required replacement amount in advance and storing the relationship in the ROM 102 as a required replacement amount map, and deriving the corresponding required replacement amount from the map when the system stop time is given. FIG. 8 illustrates an example of the required replacement amount map. In the present embodiment, since the pipe length of the pipe (secondary-side pipe) on the downstream side of the hydrogen blower 42 in the fuel gas line is the same for all the power generation modules 20, the amount of air replaced from hydrogen in the fuel gas line per unit time is considered to be substantially the same in all the power generation modules 20. Therefore, when restarting up the system, the integrated control device 100 estimates the required replacement amount common to all the power generation modules 20.

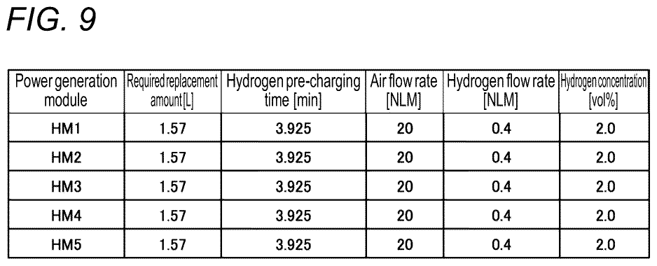

After estimating the required replacement amount common to all the power generation modules 20, the integrated control device 100 sets, as the executing hydrogen charging flow rate common to all the power generation modules 20, a hydrogen charging flow rate at which the hydrogen concentration in the fuel zone of the combustor 22 is a concentration obtained by multiplying the lower combustion limit (4%) of hydrogen by a predetermined safety factor with respect to a predetermined air charging flow rate (step S216). The integrated control device 100 then calculates the executing hydrogen charging time common to all the power generation modules 20 by dividing the required replacement amount common to all the power generation modules 20 by the set executing hydrogen charging flow rate (step S218). For example, in a case where the air charging flow rate is 20 [NLM] and the safety factor is 0.5, the executing hydrogen charging flow rate is 0.4 [NLM] as illustrated in FIG. 9. Furthermore, since the required replacement amount is common to all the power generation modules HM1 to HM5, in a case where the required replacement amount is 1.57 [L], the executing hydrogen charging time of the power generation modules HM1 to HM5 is 3.925 [min].

When the executing hydrogen charging time common to all the power generation modules 20 and the executing hydrogen charging flow rate of each power generation module 20 are set as described above, the integrated control device 100 transmits a hydrogen pre-charging instruction including the executing hydrogen charging time and the executing hydrogen charging flow rate to the corresponding module control device 90 (step S210), and ends the hydrogen pre-charging step process. As a result, when the system is restarted up, since the executing hydrogen charging flow rate and the executing hydrogen charging time are set by estimating the required replacement amount depending on the system stop time, it is possible to prevent the backfire due to pre-charging of hydrogen from occurring at the time of ignition in the combustor 22 while suppressing wasteful fuel consumption.

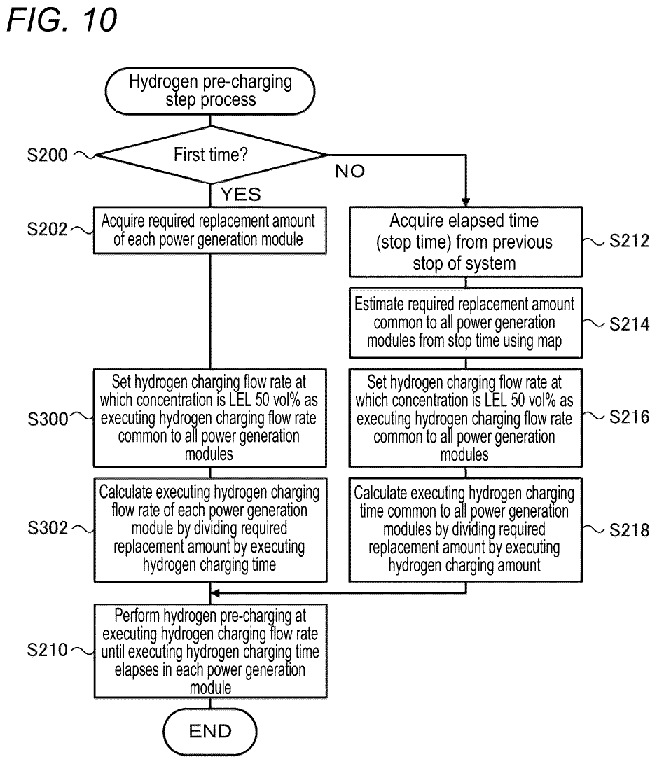

In the embodiment described above, at the time of the first start-up of the system, the integrated control device 100 sets the executing hydrogen charging flow rate of each power generation module 20 and the executing hydrogen charging time common to all the power generation modules 20 on the basis of the required replacement amount of each power generation module 20. However, the integrated control device 100 may set the executing hydrogen charging amount common to all the power generation modules 20 and the executing hydrogen charging time of each power generation module 20. FIG. 10 is a flowchart illustrating an example of a hydrogen pre-charging step process according to another embodiment. Note that, among the processes of the hydrogen pre-charging step process in FIG. 10, the same processes as those in FIG. 5 are denoted by the same step numbers, and description thereof will be omitted due to repetition.

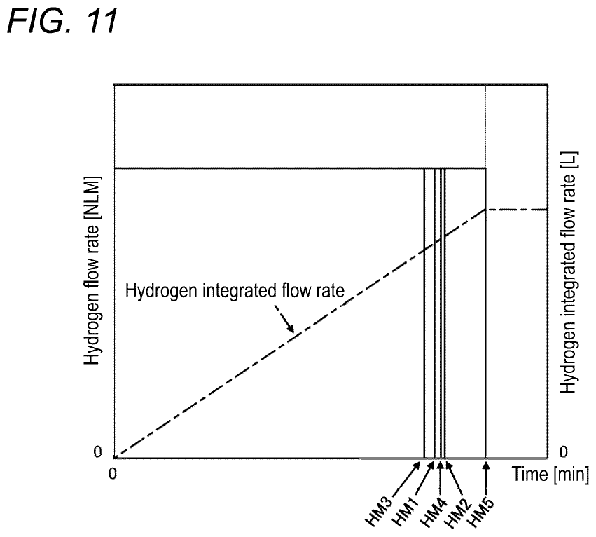

In the hydrogen pre-charging step process of FIG. 10, when determining that the current system start-up is the first time in step S200 and then acquiring the required replacement amount of each power generation module 20 in subsequent step S202, the integrated control device 100 sets, as the executing hydrogen charging flow rate common to all the power generation modules 20, the hydrogen charging flow rate at which the hydrogen concentration in the fuel zone of the combustor 22 is a concentration obtained by multiplying the lower combustion limit (4%) of hydrogen by the predetermined safety factor (step S300). The integrated control device 100 then calculates the executing hydrogen charging time of each power generation module 20 by dividing the required replacement amount of each power generation module 20 by the common executing hydrogen charging flow rate (step S302). For example, in a case where the air charging flow rate is 20 [NLM] and the safety factor is 0.5, the executing hydrogen charging flow rate is 0.4 [NLM], and the hydrogen charging times of the power generation modules HM1, HM2, HM3, HM4, and HM5 are 15.0 [min], 15.5 [min], 14.5 [min], 15.25 [min], and 17.5 [min], respectively as illustrated in FIG. 6A. As a result, similarly to the present embodiment, air in the fuel gas line from the fuel supply system 40 to the combustor 22 in each power generation module 20 can be replaced with hydrogen, and it is possible to prevent flame from reversely firing to the fuel gas line at the time of ignition in the combustor 22 in the next ignition step (first ignition step). In addition, since the executing hydrogen charging flow rate and the executing hydrogen charging time are set based on the required replacement amount, wasteful fuel consumption can be suppressed. Note that in the hydrogen pre-charging step process according to another embodiment, the executing hydrogen charging time differs for each power generation module 20. Therefore, as illustrated in FIG. 11, when the executing hydrogen charging time of each of the power generation modules HM1 to HM4 whose executing hydrogen charging time is not maximum among the power generation modules HM1 to HM5 elapses, the module control device 90 of each of the power generation modules HM1 to HM4 sets the target fuel flow rate Fgtag to 0 and stops supply of hydrogen, and waits until the executing hydrogen charging time of the power generation module MH5 with the maximum executing hydrogen charging time elapses.

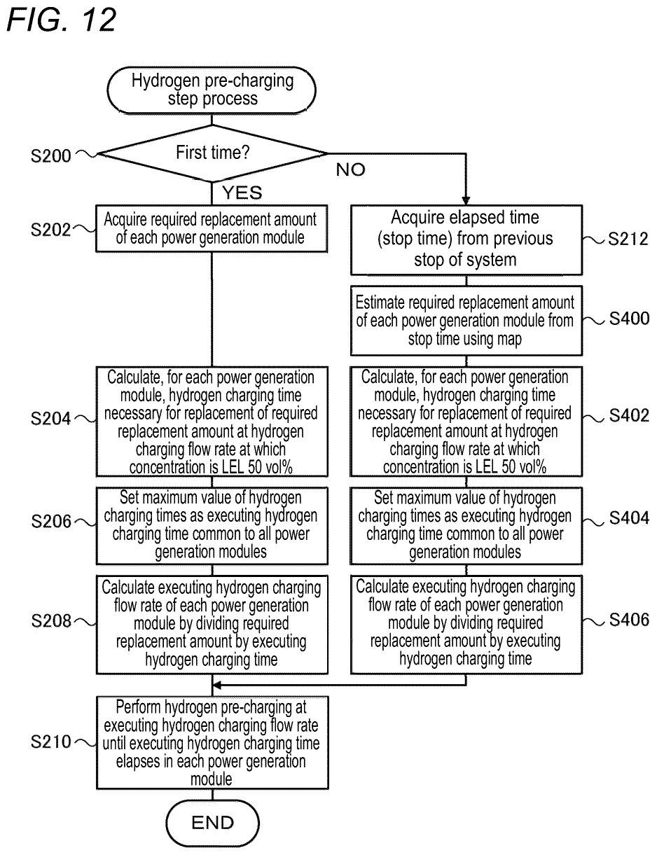

In the embodiment described above, the pipe length of the pipe (secondary-side pipe) from the hydrogen blower 42 to the combustor 22 is the same for all the power generation modules 20. However, the pipe length of the secondary-side pipe may be different in some power generation modules 20. In this case, the hydrogen pre-charging step process of FIG. 12 is performed instead of FIG. 5. Note that, among the processes of the hydrogen pre-charging step process in FIG. 12, the same processes as those in FIG. 5 are denoted by the same step numbers, and description thereof will be omitted due to repetition.

In the hydrogen pre-charging step process of FIG. 12, when determining that the current system start-up is not the first time in step S200 and then acquiring the system stop time in subsequent step S212, the integrated control device 100 estimates the required replacement amount of each power generation module 20 on the basis of the acquired system stop time (step S400). Similarly to the present embodiment, the integrated control device 100 estimates the required replacement amount using the required replacement amount map. Since the pipe length of the secondary-side pipe differs for each power generation module 20, the required replacement amount map is prepared for each power generation module 20 by performing an experiment or the like in advance. Subsequently, similarly to step S204, the integrated control device 100 calculates, for each power generation module 20, a hydrogen charging time necessary for the replacement of the required replacement amount in a case where the hydrogen charging flow rate is set in a manner that the hydrogen concentration in the fuel zone of the combustor 22 is a concentration obtained by multiplying the lower combustion limit (4%) of hydrogen by a predetermined safety factor (step S402). Next, similarly to step S206, the integrated control device 100 sets the maximum value of the calculated hydrogen charging times as the executing hydrogen charging time common to all the power generation modules 20 (step S404). Similarly to step S208, the integrated control device 100 then calculates the executing hydrogen charging amount of each power generation module 20 by dividing the required replacement amount of each power generation module 20 by the common executing hydrogen charging time (step S406). As a result, even if the piping length of the secondary-side piping differs for each power generation module 20, the air in the secondary-side pipe can be replaced with hydrogen while wasteful fuel consumption is reduced in the hydrogen pre-charging step at the time of system restart-up.

In the embodiment described above, the integrated control device 100 sets the executing hydrogen charging time and the executing hydrogen charging flow rate of the fuel supply system 40 in each power generation module 20, but each module control device 90 may set the executing hydrogen charging time and the executing hydrogen charging flow rate of the corresponding fuel supply system 40.

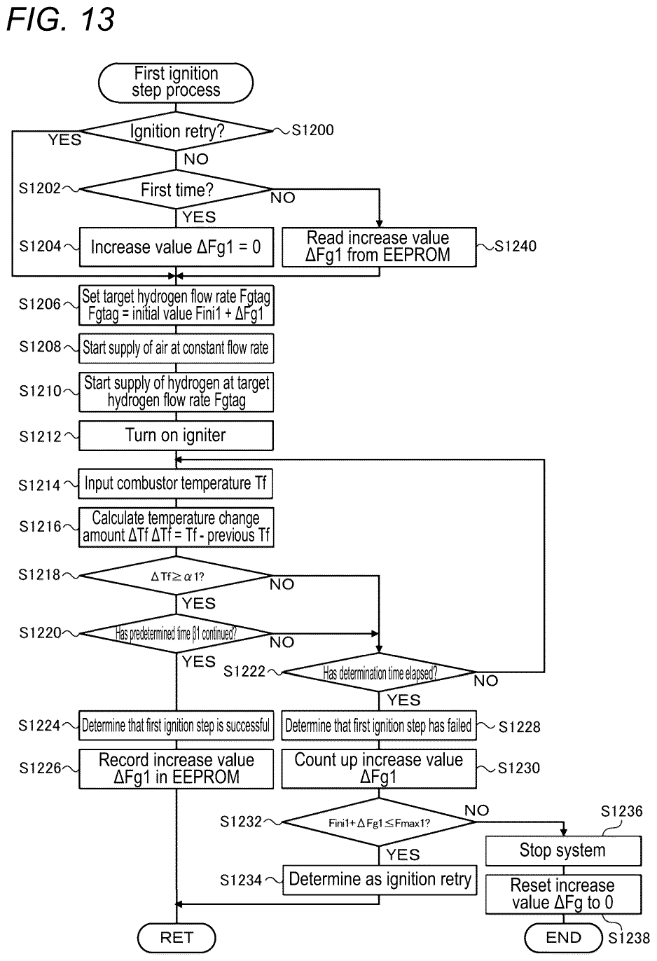

Next, the first ignition step performed in step S110 and the second ignition step performed in step S114 will be described in more detail. FIG. 13 is a flowchart illustrating an example of the first ignition step process. The first ignition step process is performed by each module control device 90 in response to an instruction from the integrated control device 100.

In the first ignition step process, each module control device 90 determines whether or not the first ignition step to be performed this time is re-performed (ignition retry) (step S1200). When determining that it is not the ignition retry, each module control device 90 determines whether or not the current system start-up is the first time (step S1202). When determining that the current system start-up is the first time, each module control device 90 sets an increase value ΔFg1 to 0 (step S1204), and then sets a value obtained by adding the increase value ΔFg1 to an initial value Fini1 as the target fuel flow rate Fgtag (step S1206). In the present embodiment, the initial value Fini1 is a hydrogen flow rate that is determined in a manner that the hydrogen concentration in the combustor 22 is lower than the lower explosion limit (4%) with respect to an air flow rate supplied from the air supply system 50 in step S1208 to be described later, and is determined to be, for example, a flow rate corresponding to 2% or 3% in terms of hydrogen concentration. Considering the case where the current system start-up is the first time, the increase value ΔFg1 is 0, and the target fuel flow rate Fgtag is set to the initial value Fini1. Subsequently, each module control device 90 controls the air blower 53 at a predetermined air flow rate to start supply of air (step S1208), and controls the hydrogen blower 42 at the target fuel flow rate Fgtag to start supply of hydrogen (step S1210). Each module control device 90 then turns on the igniter 27 in order to ignite the mixed gas of hydrogen and air introduced into the combustor 22 (step S1212).

Next, each module control device 90 inputs the combustor temperature Tf from the temperature sensor 25 (step S1214), and calculate a temperature change amount ΔTf (=Tf−previous Tf) by subtracting the previously input combustor temperature (previous Tf) from the currently input combustor temperature Tf (step S1216). Each module control device 90 then determines whether or not the calculated temperature change amount ΔTf is equal to or more than a predetermined amount α1 (step S1218), and whether or not the state has continued for a predetermined time β1 (step S1220). Here, the predetermined amount al and the predetermined time β1 are thresholds for determining the occurrence of partial combustion in which a part of the hydrogen gas introduced into the combustor 22 burns, and values obtained experimentally are determined. When determining that the temperature change amount ΔTf is less than the predetermined amount α1 or that the state does not continue for the predetermined time β1 even if the temperature change amount ATf is equal to or more than the predetermined amount α1, each module control device 90 determines whether or not a predetermined determination time has elapsed (step S1222). When determining that the determination time has not elapsed, each module control device 90 returns to step S1214 and repeats the processes of steps S1214 to S1222. When determining that the temperature change amount ΔTf is equal to or more than the predetermined amount α1 and that the state continues for the predetermined time β1 before the determination time elapses, each module control device 90 determines that the first ignition step (partial combustion) is successful (step S1224). Each module control device 90 then records the current increase value ΔTg1 (here, 0) in the EEPROM 104 (step S1226), and ends the first ignition step process.

When determining that the determination time has elapsed in step S1222 in the process of repeating steps S1214 to S1222, each module control device 90 determines that the first ignition step has failed (step S1228). Next, each module control device 90 counts up the increase value ΔFg1 of the hydrogen flow rate supplied from the hydrogen supply system 40 when the first ignition step is re-performed (ignition retry) (step S1230). The increase value ΔFg1 is counted up so as to increase by, for example, 1% in terms of the hydrogen concentration in the combustor 22. Each module control device 90 then determines whether or not a value obtained by adding the increase value ΔFg1 to the initial value Fini1 exceeds an upper limit value Fmax1 (step S1232). The process of step S1232 is a determination whether or not the hydrogen concentration in the combustor 22 exceeds a predetermined upper limit concentration (for example, 4% which is a lower explosion limit of hydrogen) when ignition retry is performed at the target fuel flow rate Fgtag to which the counted-up increase value ΔFg1 is added. When determining that the value obtained by adding the increase value ΔFg1 to the initial value Fini1 is equal to or less than the upper limit value Fmax1, each module control device 90 determines to perform the ignition retry (step S1234), and ends the first ignition step process. In this case, as described above, in the start-up process, the air purge step is performed, and then the first ignition step process is re-performed.

When the first ignition step process is re-performed, each module control device 90 determines that the first ignition step performed this time in step S1200 is the first ignition step to be re-performed (ignition retry), and thus sets a value obtained by adding the increase value ΔFg1 counted up in step S1230 to the initial value Fini1 as the target fuel flow rate Fgtag (step S1206), and then re-performs the first ignition step by the processes of steps S1208 to S1222, and determines whether the first ignition step is successful. When the first ignition step is successful (step S1224), each module control device 90 then records the current increase value ΔTg1 (here, a counted-up value) in the EEPROM 104 (step S1226), and ends the first ignition step process. On the other hand, when the first ignition step fails (step S1228), each module control device 90 repeats the process of further counting up the increase value ΔTg1 and re-performing the first ignition step (ignition retry) until the first ignition step becomes successful or the value obtained by adding the increase value ΔFg1 to the initial value Fini1 exceeds the upper limit value Fmax1. When determining that the value obtained by adding the increase value ΔFg1 to the initial value Fini1 exceeds the upper limit value Fmax1 in step S1232 in the process of repeating the processes, each module control device 90 determines that some abnormality occurs in the fuel cell system 10, stops the fuel cell system 10 (step S1236), resets the increase value ΔFg1 recorded in the EEPROM 104 to 0 (step S1238), and ends the first ignition step process. As described above, in a case where the first ignition step fails, the first ignition step is repeated while the amount of hydrogen to be supplied to the combustor 22 is gradually increased, so that ignition in the combustor 22 can be performed safely and reliably. In a case where the first ignition step is not successful even if the first ignition step is repeatedly re-performed, the fuel cell system 10 is stopped, so that it is possible to appropriately handle the abnormality of the fuel cell system 10.

When the first ignition step becomes successful after re-performing of the first ignition step, the increase value ΔFg1 counted up when the first ignition step is re-performed is recorded in the EEPROM 104. When starting up the system next, each module control device 90 determines that the current system start-up is not the first time in step S1202, and thus reads the increase value ΔFg1 recorded in the EEPROM 104 (step S1240), sets a value obtained by adding the read increase value ΔFg1 to the initial value Fini1 as the target fuel flow rate Fgtag, and performs the first ignition step. Therefore, as the system is repeatedly restarted up, the optimum increase value ΔFg1 is set, and the first ignition step can be more reliably performed at one time.

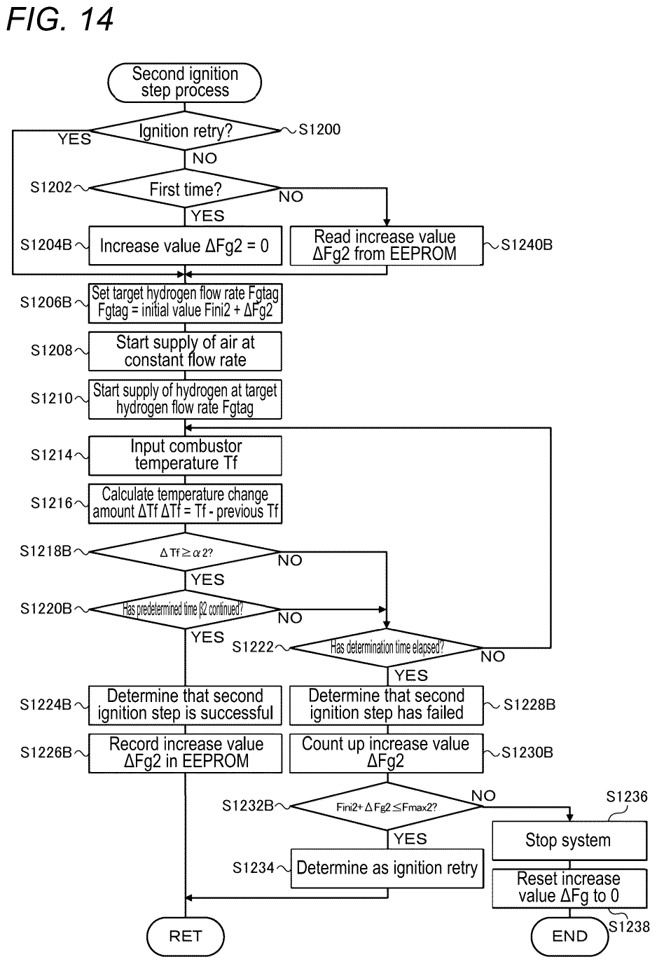

Next, the second ignition step will be described. FIG. 14 is a flowchart illustrating an example of a second ignition step process. The second ignition step process is performed by each module control device 90 in response to an instruction from the integrated control device 100. Note that, among the processes of the second ignition step, the same processes as those in the first ignition step are denoted by the same step numbers, and the detailed description thereof will be omitted due to repetition.

In the second ignition step process, when determining that the second ignition step performed this time is not a re-performed second ignition step (ignition retry) but the current system start-up is the first time in steps S1200 and S1202, each module control device 90 sets the increase value ΔFg2 to 0 (step S1204B), and then sets a value obtained by adding the increase value ΔFg2 to an initial value Fini2 as the target fuel flow rate Fgtag (step S1206B). The initial value Fini2 is a value larger than the initial value Fini1 used in the first ignition step, and is determined to be, for example, a hydrogen flow rate at which the hydrogen concentration in the combustion unit 22 is the lower explosion limit (4%) with respect to an air flow rate. Subsequently, each module control device 90 supplies air at a predetermined air flow rate (step S1208), and supplies hydrogen at the target fuel flow rate Fgtag (step S1210).

Next, each module control device 90 inputs the combustor temperature Tf and calculates the temperature change amount ΔTf (steps S1214 and S1216), and determines whether or not the temperature change amount ΔTf is equal to or more than a predetermined amount α2 (step S1218B) and whether or not the state has continued for a predetermined time β2 (step S1220B). Here, the predetermined amount α2 and the predetermined time β2 are thresholds for determining whether or not the combustor 22 has shifted from partial combustion to complete combustion, and values obtained experimentally are determined. When determining that the temperature change amount ΔTf is less than the predetermined amount α2 or that the state does not continue for the predetermined time β2 even if the temperature change amount ΔTf is equal to or more than the predetermined amount α2, each module control device 90 determines whether or not a predetermined determination time has elapsed (step S1222). When determining that the determination time has not elapsed, each module control device 90 returns to step S1214 and repeats the processes of steps S1214 to S1222. When determining that the temperature change amount ΔTf is equal to or more than the predetermined amount α2 and that the state continues for the predetermined time β2 before the determination time elapses, each module control device 90 determines that the second ignition step (complete combustion) is successful (step S1224B). Each module control device 90 then records the current increase value ΔTg2 (here, 0) in the EEPROM 104 (step S1226B), and ends the second ignition step process.

When determining that the determination time has elapsed in step S1222 in the process of repeating steps S1214 to S1222, each module control device 90 determines that the second ignition step has failed (step S1228B). Next, each module control device 90 counts up the increase value ΔFg2 of the hydrogen flow rate supplied from the hydrogen supply system 40 when the second ignition step is re-performed (ignition retry) (step S1230B). The increase value ΔFg2 is counted up so as to increase by, for example, 1% in terms of the hydrogen concentration in the combustor 22. Each module control device 90 then determines whether or not a value obtained by adding the increase value ΔFg2 to the initial value Fini2 exceeds the upper limit value Fmax2 (step S1232B). The process of step S1232B is a determination whether or not the hydrogen concentration in the combustor 22 exceeds a predetermined upper limit concentration when ignition retry is performed at the target fuel flow rate Fgtag to which the counted-up increase value ΔFg2 is added. The upper limit concentration can be, for example, a concentration (for example, 9%) obtained by multiplying a lower explosive limit (18%) by a predetermined safety factor (for example, 0.5). When determining that the value obtained by adding the increase value ΔFg2 to the initial value Fini2 is equal to or less than the upper limit value Fmax2, each module control device 90 determines to perform ignition retry (step S1234), and returns to step S1200. Since the positive determination is made in step S1200, each module control device 90 sets a value obtained by adding the counted up increase value ΔFg2 to the initial value Fini2 as the target fuel flow rate Fgtag (step S1206B), and repeats the processes of steps S1208 to S1222 to re-perform the second ignition step process.

When the second ignition step is successful (step S1224B), each module control device 90 then records the current increase value ΔTg2 (here, a counted-up value) in the EEPROM 104 (step S1226B), and ends the second ignition step process. On the other hand, when the second ignition step fails (step S1228B), each module control device 90 repeats the process of further counting up the increase value ΔTg2 by a predetermined value and re-performing the second ignition step (ignition retry) until the second ignition step becomes successful or the value obtained by adding the increase value ΔFg2 to the initial value Fini2 exceeds the upper limit value Fmax2. When determining that the value obtained by adding the increase value ΔFg2 to the initial value Fini2 exceeds the upper limit value Fmax2 in step S1232B in the process of repeating the processes, each module control device 90 determines that some abnormality occurs in the fuel cell system 10, stops the fuel cell system 10 (step S1236), resets the increase value ΔFg2 recorded in the EEPROM 104 to 0 (step S1238B), and ends the second ignition step process. As described above, in a case where the second ignition step fails, the second ignition step is repeated while the amount of hydrogen to be supplied to the combustor 22 is gradually increased, so that the ignition of the combustor 22 can be successfully completed while the occurrence of explosion or deflagration is prevented more reliably. In a case where the second ignition step is not successful even if the second ignition step is repeatedly re-performed, the fuel cell system 10 is stopped, so that it is possible to appropriately handle the abnormality of the fuel cell system 10.

When the second ignition step becomes successful after re-performing of the second ignition step, the increase value ΔFg2 counted up when the second ignition step is re-performed is recorded in the EEPROM 104. When starting up the system next, each module control device 90 determines that the current system start-up is not the first time in step S202, and thus reads the increase value ΔFg2 recorded in the EEPROM 104 (step S1240B), sets a value obtained by adding the read increase value ΔFg2 to the initial value Fini2 as the target fuel flow rate Fgtag, and performs the second ignition step. Therefore, as the system is repeatedly restarted up, the optimum increase value ΔFg2 is set, and the second ignition step can be more reliably performed at one time.

As described above, in the present embodiment, by sequentially performing the first ignition step (partial combustion) and the second ignition step (complete combustion) as the ignition step, it is possible to prevent the occurrence of explosion or deflagration even if the fuel concentration of the combustor 22 slightly deviates due to tolerances of the auxiliary machine 30 and control. As a result, the mixed gas of hydrogen and air in the combustor 22 can be ignited more safely and reliably.

In the embodiment described above, each fuel cell stack 21 performs the power generation operation of generating power by the reaction between hydrogen and oxygen contained in air. However, the fuel cell stack 21 is a reversibly operated solid oxide cell stack, and may include a FC mode in which the power generation operation is performed and an EC mode in which an electrolysis operation of generating hydrogen by high-temperature steam electrolysis in a state where power is supplied from a power supply is performed. Note that, as the power supply, a system power supply, renewable energy such as a solar power generator, a storage battery, or the like can be used.

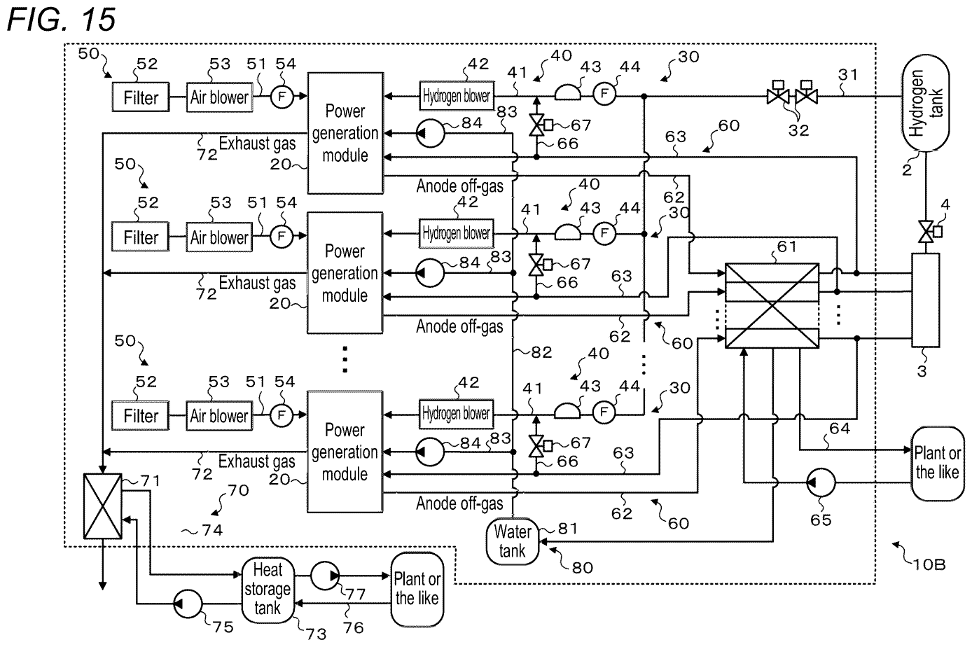

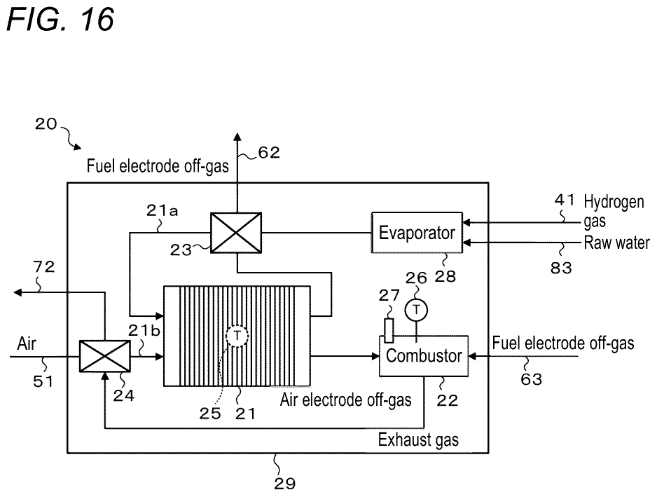

FIG. 15 is a schematic configuration diagram of a fuel cell system 10B according to another embodiment, and FIG. 16 is a schematic configuration diagram of a power generation module 20 thereof. In the fuel cell system 10B according to another embodiment, the power generation module 20 includes an evaporator 25 and the like in addition to the fuel cell stack 21, the combustor 22, and the heat exchangers 23 and 24, and these components are housed in the module case 29 with a heat insulating property. Note that the evaporator 25 may include a heater for compensating heat insufficient in the evaporator 25. The various auxiliary machines 30 include a water supply system 80, and the like in addition to the fuel supply system 40, the air supply system 50, the circulation system 60, and the exhaust heat recovery system 70.

The water supply system 80 includes a water tank 81 that stores water (raw water), a water supply pipe 82 having one end connected to the water tank 81, a branch pipe 83 that branches from the other end of the water supply pipe 82 to each power generation module 20, and a water pump 84 disposed in each branch pipe 83. By operating the water pump 84, the raw water in the water tank 81 is pumped (supplied) to the power generation module 20. Since the water pump 84 is disposed in each branch pipe 83, the supply amount of the raw water can be controlled for each power generation module 20 by individually controlling each water pump 84. The evaporator 25 is connected between the branch pipe 83 of the water supply system 80 and the fuel gas supply pipe 21a. The raw water is evaporated in the evaporator 25 to be converted into water vapor.

In the EC mode, water vapor and a small amount of hydrogen gas supplied as fuel gas by the water supply system 80 and the fuel supply system 40 are introduced into the fuel electrode of the fuel cell stack 21 through the fuel gas supply pipe 21a, and air supplied as sweep gas by the air supply system 50 is introduced into the air electrode of the fuel cell stack 21 through the oxidant gas supply pipe 21b. When power having a predetermined voltage is supplied between the terminals of the fuel cell stack 21 (reversibly operated solid oxide cell stack) by the power supply, water vapor introduced into the fuel electrode is decomposed into hydrogen and oxygen ions (O²⁻) by an electrolytic action in the fuel electrode, and the oxygen ions pass through the electrolyte to generate oxygen in the air electrode. Note that, in the present embodiment, since a small amount of hydrogen gas is also supplied to the fuel electrode together with water vapor, the fuel electrode is maintained in a reducing atmosphere, and oxidation degradation of the fuel electrode can be suppressed. The hydrogen gas generated at the fuel electrode is discharged as a fuel electrode off-gas together with water vapor not subjected to electrolytic reaction, exchanges heat with water vapor or the like supplied from the water supply system 80 to the fuel electrode in the heat exchanger 23, and then is discharged to the outside of the module case 29. The fuel electrode off-gas containing hydrogen gas and water vapor is supplied to the circulation system 60 through the fuel electrode off-gas pipe 62, cooled by the condenser 61 provided in the circulation system 60 to remove the water vapor, and then stored in the hydrogen tank 2 via a collecting pipe 3 and an on-off valve 4. Note that the on-off valve 4 is closed in the FC mode and opened in the EC mode. Furthermore, part of the fuel electrode off-gas (hydrogen gas) that has passed through the condenser 61 is supplied to the combustor 22 through the fuel electrode off-gas pipe 63. On the other hand, the oxygen gas generated at the air electrode is directly supplied to the combustor 22 as an air electrode off-gas together with the air passing through the air electrode. Combustion heat generated by the combustion of the mixed gas of the fuel electrode off-gas and the air electrode off-gas in the combustor 22 is transmitted to the evaporator 25. The evaporator 25 evaporates water (raw water) supplied from the water supply system 80 to generate water vapor, and increases the temperature of the generated water vapor. Furthermore, in the combustor 22, combustion exhaust gas is generated, and the generated combustion exhaust gas exchanges heat with air supplied from the air supply system 50 to the air electrode in the heat exchanger 24, then passes through the combustion exhaust gas pipe 72, passes through the exhaust heat recovery system 70, and is discharged to the outside air.

In the fuel cell system 10B according to another embodiment configured as described above, the FC mode and the EC mode can be switched and performed depending on the power demand. For example, the FC mode can be selected in a case where the load L requests power, and the EC mode can be selected in a case where the load L does not request power. Furthermore, in the fuel cell system 10B that has entered into the demand response contract, the FC mode can be selected in a case where a decrease DR for reducing the power demand is requested, and the EC mode can be selected in a case where an increase DR for increasing the power demand is requested.

In the embodiment described above, the integrated control device 100 sets the executing hydrogen charging time and the executing hydrogen charging flow rate of the fuel supply system 40 in each power generation module 20, but each module control device 90 may set the executing hydrogen charging time and the executing hydrogen charging flow rate of the corresponding fuel supply system 40.

In the embodiment described above, each of the plurality of power generation modules 20 included in the fuel cell system 10 includes one fuel cell stack 21. However, all or some of the plurality of power generation modules 20 may include a plurality of fuel cell stacks 21 connected in series or in parallel.

In the embodiment described above, the fuel cell stacks 21 included in the plurality of power generation modules 20 are connected in series to each other, but may be connected in parallel to each other.

In the embodiment described above, the module control device 90 and the integrated control device 100 are configured by separate control units, but may be configured by a single control unit.

In the embodiment described above, the fuel cell system 10 includes the plurality of power generation modules 20 each including the fuel cell stack 21, but may include a single power generation module 20.

Although the mode for carrying out the present disclosure has been described above with reference to the embodiment, the present disclosure is not limited to such embodiment at all, and can be carried out in various forms without departing from the gist of the present disclosure.

Note that, the present specification also discloses a technical idea in which “the fuel cell system according to claim 1” is changed to “the fuel cell system according to any one of claims 1 to 5” in claim 6 as originally filed.

### INDUSTRIAL APPLICABILITY

The present disclosure is applicable to a fuel cell system manufacturing industry.

### REFERENCE SIGNS LIST

10, 10B: Fuel cell system, 20: Power generation module, 21: Fuel cell stack, 22: Combustor (combustion unit), 26: Temperature sensor, 27: Igniter, 29: Module case (case), 30: Auxiliary machine, 40: Fuel supply system, 50: Air supply system (oxidant gas supply system), 90: Module control device (control unit, individual control unit), and 100: Integrated control device (control unit, integrated control unit)

1. A fuel cell system comprising:
a fuel cell stack that generates power by a reaction between fuel gas and oxidant gas;
a combustion unit that burns mixed gas of residual fuel gas and residual oxidant gas from the fuel cell stack;
an igniter used for ignition in the combustion unit;
a case that has a heat insulating property and houses the fuel cell, the combustion unit, and the igniter;
a fuel supply system that supplies fuel gas to the fuel cell stack;
an oxidant gas supply system that supplies oxidant gas to the fuel cell stack; and
a control unit that, at a time of system start-up, supplies the oxidant gas, performs a fuel pre-charging step of supplying the fuel gas until an oxygen concentration remaining in a fuel line from the fuel supply system to the combustion unit becomes equal to or lower than a predetermined concentration at a supply flow rate of the fuel gas at which a fuel concentration of the combustion unit is equal to or lower than a lower explosion limit with respect to a supply flow rate of the oxidant gas, and then performs an ignition step of performing ignition in the combustion unit.

2. The fuel cell system according to claim 1, wherein
the control unit executes, as the ignition step, a first ignition step of controlling the fuel supply system and the oxidant gas supply system in a manner that the fuel gas and the oxidant gas are supplied to the combustion unit in a range in which a fuel concentration of the combustion unit is equal to or lower than a lower explosion limit and controlling the igniter so as to ignite mixed gas of the fuel gas and the oxidant gas in the combustion unit, and then performs a second ignition step of controlling the fuel supply system and the oxidant gas supply system in a manner that the fuel gas and the oxidant gas are supplied to the combustion unit in a range in which a fuel concentration of the combustion unit is equal to or higher than a fuel concentration in the first ignition step and equal to or lower than a lower explosive limit.

3. The fuel cell system according to claim 2, comprising a temperature sensor that detects a temperature of the combustion unit, wherein
in the first ignition step, the control unit determines whether the first ignition step is successful based on a temperature of a combustion unit detected by the temperature sensor, and in a case where it is determined that the first ignition step has failed, the control unit repeats a process of purging inside of the combustion unit by supplying the oxidant gas and then increasing a flow rate of fuel gas to be supplied to the combustion unit and re-performing the first ignition step until the first ignition step becomes successful, and stops the fuel cell system when an increased flow rate of the fuel gas exceeds a first upper limit value without the first ignition step being successful.

4. The fuel cell system according to claim 2, comprising a temperature sensor that detects a temperature of the combustion unit, wherein
in the second ignition step, the control unit determines whether the second ignition step is successful based on a temperature of a combustion unit detected by the temperature sensor, and in a case where it is determined that the second ignition step has failed, the control unit repeats a process of increasing a flow rate of fuel gas to be supplied to the combustion unit and re-performing the second ignition step until the second ignition step becomes successful, and stops the fuel cell system when an increased flow rate of the fuel gas exceeds a second upper limit value that is larger than the first upper limit value and is smaller than a lower explosive limit in terms of fuel concentration in the combustor without the second ignition step being successful.

5. The fuel cell system according to claim 3, comprising a storage unit that stores an increase value of fuel gas supplied when the first ignition step or the second ignition step is re-performed, wherein
when the fuel cell system is stopped and then started up next, in the first ignition step or the second ignition step, the control unit starts the first ignition step or the second ignition step at a supply flow rate of fuel gas increased by an increase value stored in the storage unit.

6. The fuel cell system according to claim 1, comprising a plurality of power generation modules each of which includes the fuel cell stack, the combustion unit, the igniter, the case, the fuel supply system, and the oxidant gas supply system, in which individual fuel cell stacks are connected in series or in parallel between the plurality of power generation modules, the fuel supply system further comprising:
a plurality of individual control units each of which controls an auxiliary machine of a corresponding power generation module among the plurality of power generation modules based on an instruction; and
an integrated control unit that, at a time of start-up of the fuel cell system, supplies the oxidant gas, instructs the plurality of individual control units to perform a fuel pre-charging step of supplying the fuel gas until an oxygen concentration remaining in a fuel line from the fuel supply system to the combustion unit becomes equal to or lower than a predetermined concentration at a fuel flow rate at which a fuel concentration of the combustion unit is equal to or lower than a lower explosion limit with respect to a supply flow rate of the oxidant gas, and then instructs the plurality of individual control units to perform ignition in the combustion unit.

7. The fuel cell system according to claim 6, wherein
in the fuel pre-charging step, the integrated control unit or the individual control unit acquires, as a required replacement amount, a fuel amount necessary for replacing oxygen remaining in the fuel line with the fuel gas until a fuel concentration in the fuel line of each of the power generation modules becomes equal to or higher than an upper explosion limit for each of the power generation modules, and sets a supply flow rate and a supply time of the fuel gas in each of the power generation units in a range in which a fuel concentration of the combustion unit is equal to or lower than a lower combustion limit with respect to a supply flow rate of the oxidant gas based on a required replacement amount of each of the power generation modules.

8. The fuel cell system according to claim 7, wherein
the integrated control unit or the individual control unit sets, as the supply time common to the plurality of power generation modules, a maximum value of times obtained by dividing a required replacement amount of each of the power generation modules by a flow rate of the fuel gas at which a fuel concentration of the combustion unit is equal to or lower than a lower combustion limit with respect to a supply flow rate of the oxidant gas, and sets, as the supply flow rate of each of the power generation modules, a flow rate obtained by dividing a required replacement amount of each of the power generation modules by the supply time.

9. The fuel cell system according to claim 7, wherein
the integrated control unit or the individual control unit sets, as the supply flow rate common to the plurality of power generation modules, a flow rate of the fuel gas at which a fuel concentration of the combustion unit is equal to or lower than a lower combustion limit with respect to a supply flow rate of the oxidant gas, and sets, as the supply time of each of the power generation modules, a time obtained by dividing a required replacement amount of each of the power generation modules by the supply flow rate.

10. The fuel cell system according to claim 7, wherein
the integrated control unit or the individual control unit measures an elapsed time from stop of the fuel cell system, and when the system is started up next, acquires the required replacement amount based on the elapsed time, and sets the supply flow rate and the supply time based on the required replacement amount.

11. The fuel cell system according to claim 4, comprising a storage unit that stores an increase value of fuel gas supplied when the first ignition step or the second ignition step is re-performed, wherein
when the fuel cell system is stopped and then started up next, in the first ignition step or the second ignition step, the control unit starts the first ignition step or the second ignition step at a supply flow rate of fuel gas increased by an increase value stored in the storage unit.

12. The fuel cell system according to claim 8, wherein
the integrated control unit or the individual control unit measures an elapsed time from stop of the fuel cell system, and when the system is started up next, acquires the required replacement amount based on the elapsed time, and sets the supply flow rate and the supply time based on the required replacement amount.

13. The fuel cell system according to claim 9, wherein
the integrated control unit or the individual control unit measures an elapsed time from stop of the fuel cell system, and when the system is started up next, acquires the required replacement amount based on the elapsed time, and sets the supply flow rate and the supply time based on the required replacement amount.
